(19) United States
(12) Patent Application Publication
(10) Pub. No.: US 2011/0011365 A1
(43) Pub. Date: Jan. 20, 2011

(54) DISSMETRICAL COMBUSTION CHAMBER FOR THERMAL ENGINE

(75) Inventors: Franck Levy, Guigneville sur Essonne (FR); Alexandre Michel, Antony (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S., Boulogne Billancourt (FR)

(21) Appl. No.: 12/809,312

(22) PCT Filed: Dec. 15, 2008
(86) PCT No.: PCT/EP08/67565

§ 371 Date: Sep. 15, 2010

(30) Foreign Application Priority Data
Dec. 19, 2007 (FR) 0759982

(51) Int. Cl. F02F 3/00

(52) U.S. Cl. 123/193.6

(57) ABSTRACT

A piston for an internal combustion engine, for example a diesel engine, including a body defined laterally by a skirt configured to interact with walls of a cylinder having a revolution axis C in which the piston can slide along axis C, the piston including a front face that includes a central lug, a peripheral crown, and a bowl having a revolution axis B extending from the central lug to the peripheral crown to which it is connected at a lip having a thickness Ep. The bowl includes substantially over the lip a torus, for example having a half-dome profile, with a maximum radius Rt and capable of guiding a fuel injected under the lip in a region of a re-entrance zone R towards the central lug, wherein the central lug has separate upper A1 and lower A2 slopes, the upper slope A1 being more gentle than the lower slope A2.

The invention relates in general to the design of combustion engines, particularly compression-ignition internal combustion engines.

Emissions standards imposed on motor vehicle manufacturers are becoming increasingly severe, each change in a standard resulting in significant technical developments and in the use of additional and/or more complicated emissions-control devices which prove to be expensive.

Future standards are encouraging manufacturers especially to reduce the level of exhaust emissions of nitrogen oxides and particulates, notably in order not to clog the particulate filters too quickly, but the manufacturers are at the same time wishing to increase, or at least to maintain, the engine performance levels and drivability.

Solutions generally adopted to increase emissions control of engines for example consist in resorting to advanced post-treatment devices such as particulate filters or in modifying the exhaust gas recirculation specifications, the English acronym EGR being widely recognized in this field, although this has an adverse impact on engine efficiency.

It is an object of the present invention to propose a combustion chamber that is improved and that is able notably to reduce the level of nitrogen oxides and particulates exhaust emissions.

One subject of the invention is a piston for an internal combustion engine, notably for a diesel engine, comprising a body laterally delimited by a skirt able to collaborate with the walls of a cylinder of axis of revolution C in which the piston is able to slide along this axis C, said piston comprising a transverse face which comprises a central pip, a peripheral crown ring and a bowl of axis of revolution B which extends from the central pip toward the peripheral crown ring to which it is connected at a lip of thickness Ep, said bowl comprising, substantially in vertical alignment with the lip, a torus in profile, preferably half-dome shaped, of maximum radius Rt, able to guide a fuel injected under the lip in a reentrance zone R toward the central pip, notable in that the central pip has an upper slope at an angle A1 and a lower slope at a different angle A2, the upper slope of angle A1 being gentler than the lower slope of angle A2.

Use of a piston according to the invention notably allows the following advantages to be realized:
the post-treatment systems do not have to be made more complicated and more expensive;
the nitrogen oxides emissions are reduced in order to comply with emissions control standards.

According to some particular embodiments, the piston has one or more of the following features:
the lower slope of angle A1 measured from the axis of revolution B of the bowl in the geometric direction is between 69° and 84° and preferably substantially equal to 72°;
the lower slope of angle A2 measured from the axis of revolution B of the bowl in the geometric direction is between 47° and 62° and preferably substantially equal to 59°;
the bowl is offset, the axis of revolution B of the bowl being separate and placed some distance from the axis of revolution C of the cylinder;
the thickness Ep of the lip is between 3 mm and 5 mm and preferably substantially equal to 4.5 mm;
the lip is situated a distance De/2 from the axis of revolution B of the bowl, the distance De being between 45 mm and 48 mm and preferably substantially equal to 47 mm;
the torus is situated a distance Db/2 from the axis of revolution B of the bowl, the distance Db being between 48 mm and 51 mm and preferably substantially equal to 49 mm;
the difference in distances, with respect to the axis of revolution B of the bowl, of the end of the crown ring De/2 and of the end of the torus Db/2 is substantially equal to 1 mm;
the maximum depth P of the bowl is between 13 mm and 14.5 mm and preferably substantially equal to 13.5 mm;

the top of the pip situated on the axis of revolution B of the bowl rises up to a height that is a distance Dt of between 4.6 mm and 6.1 mm, and preferably substantially equal to 5.1 mm below the height of the peripheral crown ring.

A further subject of the invention is an internal combustion engine designed for strict emissions control standards in terms of the emissions of nitrogen oxides and particulates and, more specifically, an internal combustion engine of the diesel type notable in that it comprises at least one piston according to the invention.

This internal combustion engine of the diesel type has a cylinder of axis of revolution C the upper end of which is closed by a cylinder head provided with an underside which contributes to defining a combustion chamber together with the transverse face of the piston the piston bowl of which is centered about an axis of revolution B, said engine comprising, opening onto the underside of the cylinder head, at least one inlet duct that can be closed off by an inlet valve and at least one exhaust duct that can be closed off by an exhaust valve, a preheater plug and a fuel injector the tip of which opens into the combustion chamber at an injector axis I parallel to the axis of revolution of the cylinder C and distant therefrom, the injector making an angle Ai with the injector axis I of between 15° and 15.5°, notable in that the axes of the cylinder C, of the bowl B and of the injector I are aligned, the distance separating the cylinder axis C from the bowl axis B being substantially equal to 1.25 mm and the distance separating the cylinder axis C from the injector axis I being substantially equal to 4 mm.

Other features and advantages of the invention will become clearly apparent from the description of the embodiment thereof given hereinafter by way of entirely nonlimiting indication with reference to the following figures:

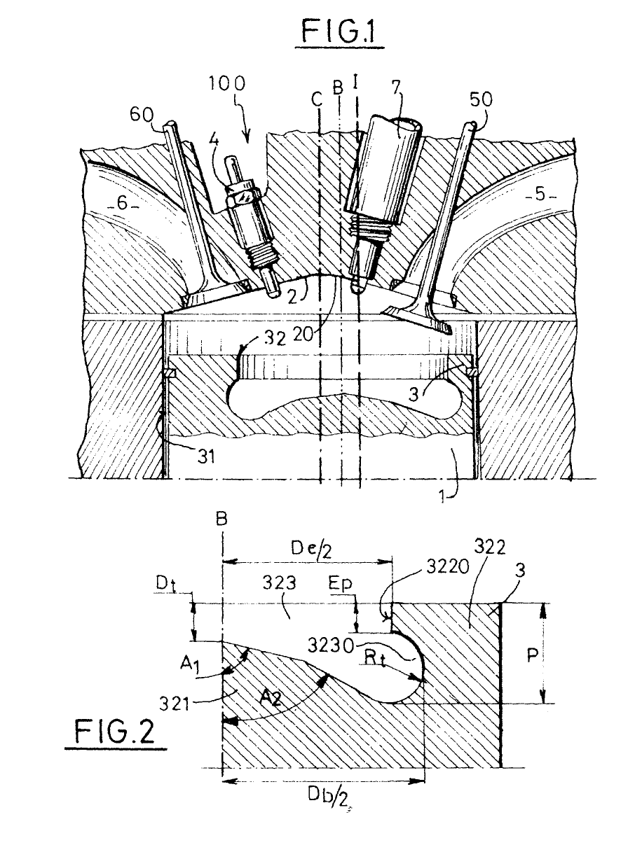

FIG. 1 is a partial schematic cross section of an internal combustion engine according to the invention;

FIG. 2 is a partial cross section on a plane containing the axis of revolution of the piston bowl, showing the detail of the crown part of a piston according to the invention, on the inlet side.

FIG. 1 illustrates an internal combustion engine 100, notably for a diesel engine, comprising at least one cylinder 1 of axis of revolution C, a cylinder head 2 and a piston 3.

In the remainder of the description, this axis of revolution C will be considered to be oriented upward, toward the cylinder head 2.

The piston 3 is mounted in the cylinder 1 such that it can slide along the axis of revolution of the cylinder C, and has a piston body designed to accept a pin to connect the piston to the little end of a driving connecting rod, said body being laterally delimited by a piston skirt 31 running parallel to the axis of revolution of the cylinder C and collaborating with an internal wall of the cylinder 1. The piston further comprises a transverse face 32 which, together with the underside 20 of the cylinder head 2, contributes to delimiting a combustion chamber of the cylinder 1.

The fresh air or a mixture of fresh air and of recirculated exhaust gases is admitted to the combustion chamber via at least one inlet duct 5 formed in the cylinder head 2 and which can be closed off by at least one inlet valve 50.

The residue of combustion of the air-fuel mixture introduced is removed via at least one exhaust duct 6 formed in the cylinder head 2 and which can be closed off via at least one exhaust valve 60.

A preheater plug 4 is fitted in the cylinder head 2, its end opening into the combustion chamber so that it can heat the air-fuel mixture during cold starts.

A fuel injector 7 is fitted in the cylinder head 2 and opens into the combustion chamber. According to the embodiment depicted, the injector 7 is arranged in such a way that it is offset from the axis of the cylinder C. The tip of the injector 7 opens at an axis I known as the “injector axis” parallel to the axis of symmetry of the cylinder C.

According to the embodiment depicted, the injector 7 is inclined by an angle Ai of between 15° and 15.5° measured from the injector axis I in the anti-geometric direction.

As depicted in FIG. 2 which, in partial cross section on an axial plane, details the upper part of a piston 3 according to the invention, the transverse face 32 comprises a central pip 321, a peripheral crown ring 322 and an annular cavity or bowl 323 of axis of revolution B parallel to the axis of revolution of the cylinder C and situated some distance therefrom so as to compensate for the offset of the injector 7, said bowl 323 extending from the central pip 321 toward the peripheral crown ring 322 to which it is connected.

For preference, the cylinder C, bowl B and injector I axes are aligned in a common plane, the distance separating the cylinder axis C from the bowl axis B being substantially equal to 1.25 mm and the distance separating the cylinder axis C from the injector axis I being substantially equal to 4 mm.

The peripheral crown ring 322 extends laterally from the skirt 31 of the piston 3 toward the axis of revolution B of the bowl 323 as far as an end that forms a lip 3220 underneath which the bowl 323 has a torus 3230 in profile half-dome shaped, with a maximum radius of curvature Rt of between 4.2 mm and 5.8 mm and preferably substantially equal to 4.5 mm.

The lip 3220 is situated a distance De/2 from the axis of revolution B of the bowl 323, the distance De being between 45 mm and 48 mm and preferably substantially equal to 47 mm.

The torus 3230 is situated a distance Db/2 from the axis of revolution B of the bowl 323, the distance Db being between 48 mm and 51 mm and preferably substantially equal to 49 mm.

The injector 7 is designed selectively to inject fuel in the form of jets directed into an upper region of the torus 3220 adjacent to a bottom edge of the lip 3220, also known as a reentrant edge R, so as to improve the way in which the jet of fuel is guided from this reentrant edge R by rolling along the walls of the torus 3230 toward the bottom of the bowl, where the oxygen is to be found as the piston 3 effects its upstroke, so as to reduce smoke and so as to enable the gases to be circulated toward the central pip 321.

For preference, a reentrant edge R will be maintained by keeping the difference in distances, with respect to the axis of revolution B of the bowl 323, of the end of the crown ring De/2 and of the end of the torus Db/2 substantially equal to 1 mm.

For preference, the thickness Ep of the lip 3220 corresponding to the distance of the reentrant edge R of the peripheral crown ring 322 is between 3 mm and 5 mm and preferably substantially equal to 4.5 mm.

The maximum depth P of the bowl 323 is between 13 mm and 14.5 mm and preferably substantially equal to 13.5 mm. Such a depth P has the advantage of offering a significant amount of air trapped at the bottom of the bowl 323 so that it can be mixed with the fuel.

Combining this design of the reentrant edge R, with the torus 3230 and with a maximum bowl 323 depth P allows improved guidance of the jet of fuel toward a volume of air trapped in the bottom of the bowl 323.

The top of the central pip 321, situated on the axis of revolution B of the bowl 320, rises up to a height that is a distance Dt below the height of the peripheral crown ring 320, this distance Dt being between 4.6 mm and 6.1 mm, and preferably substantially equal to 5.1 mm. This distance Dt makes it possible to limit interactions between the jets of fuel sprayed toward the bottom of the bowl 320 with the central pip 321 and notably the top thereof, thus making it possible to reduce emissions of smoke and unburnt fuel.

The central pip 321 has an upper slope at an angle A1 and a lower slope at a different angle A2, the upper slope of angle A1 being gentler than the lower slope of angle A2.

The upper slope of angle A1 measured from the axis of revolution B of the bowl 320 in the geometric direction is between 69° and 84° and preferably substantially equal to 72°.

The lower slope of angle A2 measured from the axis of revolution B of the bowl 320 in the geometric direction is between 47° and 62° and preferably substantially equal to 59°.

The use of a steep lower slope of angle A2 makes it possible to hold more air in the bottom of the bowl 320 then can be held by a central pip 321 with a single slope.

An internal combustion engine 100 provided with a piston 3 combining these features proves to be particularly advantageous in use by comparison with an internal combustion engine provided with a piston suited to current emissions control standards, of the Euro 4 type. These tests were conducted using an engine 100 that had the following additional features: a bore of 76 mm, a compression ratio of about 15 and a level of swirl at bottom dead center Nd/N of about 2.

What was actually found was that under part-load conditions, this engine 100 emitted approximately 10% less nitrogen oxides and particulate emissions. Under the same load conditions, an approximately 20% reduction in unburnt hydrocarbons HC is also observed.

At full load, and at high engine speeds of the order of 4000 rpm, an increase in maximum power of the order of 3% is seen, at the smoke limit, that is to say with a constant level of smoke of the order of 3 fsn, that is to say three times the smoke index. In other words, what that amounts to, at constant maximum power, is a reduction in the amount of smoke, the smoke index being reduced by a value ranging between 0.5 and 1 fsn.

1-12. (canceled)

13. A piston for an internal combustion engine, comprising:
a body laterally delimited by a skirt configured to collaborate with walls of a cylinder of an axis of revolution C in which the piston can slide along the axis C, the piston comprising a transverse face that comprises a central pip, a peripheral crown ring, and a bowl of axis of revolution B that extends from the central pip toward the peripheral crown ring to which it is connected at a lip of thickness Ep, the bowl comprising, substantially in vertical alignment with the lip, a torus in profile, or of half-dome shaped, of maximum radius Rt, configured to guide a fuel injected under the lip in a reentrance zone R toward the central pip, wherein the central pip has an upper slope at an angle A1 and a lower slope at a different angle A2, the upper slope of angle A1 being gentler than the lower slope of angle A2.

14. The piston as claimed in claim 13, wherein the lower slope of angle A1 measured from the axis of revolution B of the bowl in the geometric direction is between 69° and 84° or is substantially equal to 72°.

15. The piston as claimed in claim 13, wherein the lower slope of angle A2 measured from the axis of revolution B of the bowl in the geometric direction is between 47° and 62° or is substantially equal to 59°.

16. The piston as claimed in claim 13, wherein the bowl is offset, the axis of revolution B of the bowl being separate and placed a distance from the axis of revolution C of the cylinder.

17. The piston as claimed in claim 13, wherein the thickness Ep of the lip is between 3 mm and 5 mm or is substantially equal to 4.5 mm.

18. The piston as claimed in claim 13, wherein the maximum radius of curvature Rt of the torus is between 4.2 mm and 5.8 mm or is substantially equal to 4.5 mm.

19. The piston as claimed in claim 13, wherein the lip is situated a distance De/2 from the axis of revolution B of the bowl, the distance De being between 45 mm and 48 mm or substantially equal to 47 mm.

20. The piston as claimed in claim 13, wherein the torus is situated a distance Db/2 from the axis of revolution B of the bowl, the distance Db being between 48 mm and 51 mm or substantially equal to 49 mm.

21. The piston as claimed in claim 13, wherein the difference in distances, with respect to the axis of revolution B of the bowl, of the end of the crown ring De/2 and of the end of the torus Db/2 is substantially equal to 1 mm.

22. The piston as claimed in claim 13, wherein the maximum depth P of the bowl is between 13 mm and 14.5 mm or is substantially equal to 13.5 mm.

23. The piston as claimed in claim 13, wherein the top of the pip situated on the axis of revolution B of the bowl rises up to a height that is a distance Dt of between 4.6 mm and 6.1 mm, or is substantially equal to 5.1 mm below the height of the peripheral crown ring.

24. An internal combustion engine of diesel type, comprising at least one piston as claimed in claim 13.
